(19) United States
(12) Patent Application Publication
(10) Pub. No.: US 2007/0300210 A1
(43) Pub. Date: Dec. 27, 2007

(54) Compiling device, list vector area assignment optimization method, and computer-readable recording medium having compiler program recorded thereon

(75) Inventor: Masatoshi Haraguchi, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 11/584,048

(22) Filed: Oct. 20, 2006

(30) Foreign Application Priority Data
Jun. 23, 2006 (JP) 2006-173369

(51) Int. Cl. G06F 9/45

(52) U.S. Cl. 717/136

(57) ABSTRACT

A compiler of this invention generates an object program 20 in which an area allocation instruction 11 to allocate an area for a structure of a list vector to be accessed in a loop and an area deallocation instruction 12 are converted into a new area allocation instruction 21 and a new area deallocation instruction 22, respectively. A new area allocation instruction processing unit 31 called by the new area allocation instruction 21 allocates an area 51 allocated in one operation of a size which is not less than an integral multiple of the size of an area for a structure, clips an area from the area 51, and assigns the area to the structure on a first area allocation request. The new area allocation instruction processing unit 31 clips an area contiguous to that for a previous structure from the area 51 allocated in one operation and assigns the area to a structure on second and subsequent calls. A new area deallocation instruction processing unit 32 called by the new area deallocation instruction 22 deallocates the whole of the area 51 allocated in one operation when it becomes unnecessary.

### CROSS-REFERENCE TO RELATED APPLICATION

This application claims priority from Japanese patent application Serial no. 2006-173369 filed Jun. 23, 2006, the contents of which are incorporated by reference herein.

### BACKGROUND OF THE INVENTION

1. Field of the Invention

The present invention relates to a technique for translating a program by a compiler. More particularly, the present invention relates to a list vector area assignment optimization method which improves the execution performance of an object program output by a compiler and a compiling device which performs the processing of the method.

2. Description of the Related Art

FIG. 11 is an explanatory diagram of a list vector; FIG. 12, a diagram showing an example of assignment of a list vector area to memory; and FIG. 13, a view showing an example of a program having a loop which accesses a list vector.

Assume a case where a program has a list vector formed of linked areas for structures (to be referred to as structures A hereinafter) as shown in FIG. 11. A list vector is a chain of structures, and each of the structures has a pointer, “next” in the example of FIG. 11, to a structure of the same type.

If memory areas are allocated for the structures A by an area allocation instruction including a function or macroinstruction, the allocated areas for the structures may be separate and discontinuous. In actual area assignment by an area allocation instruction, to which address each of the areas for the structures is assigned depends on a time at which area allocation is performed. Accordingly, areas at dispersed and separate addresses may be assigned to the structures, as shown in FIG. 12.

For example, in the case of the “C language” program language, an area allocation instruction to allocate a memory area corresponds to a system function such as the function “malloc”. An area deallocation instruction corresponds to the function “free”. In the following description, an example using the functions malloc and free as area allocation and deallocation instructions will be explained.

If areas assigned to structures are separate, as shown in FIG. 12, there is a high possibility that a cache miss occurs when accessing, from a member of a certain structure, a member of a next structure. A program which accesses members of structures in a chained manner by tracing addresses pointed to by a structure pointer p in a loop, as shown in, e.g., FIG. 13, is a commonly used program. In this program, if a cache miss occurs on a certain iteration of access p→x, a cache miss is highly likely to occur on a next iteration of access p→x. In the case of a cache miss, since the need to transfer data from main storage to cache memory arises, the access time becomes longer.

In recent years, many architectures support hardware prefetching. However, a hardware prefetch mechanism only supports a method of performing prefetching in area access such as sequential access to adjacent areas. Accordingly, if areas to be accessed in the list vector as shown in FIG. 13 are assigned as shown in FIG. 12, a cache miss inevitably occurs.

Japanese Patent Laid-Open No. 2003-337707, discloses a technique for transforming a loop control statement into one which registers the starting address of list structure data in an array element of a work array and counts the number of elements of the list structure data in order to increase the execution speed of a program containing a loop which repeatedly processes the list structure data. In other words, in the technique of Japanese Patent Laid-Open No. 2003-337707, transformation of the original loop and generation of processes before and after the loop are performed such that access to the list vector is made using the starting address stored in the work array. With this operation, the technique implements an increase in loop execution speed.

Japanese Patent Laid-Open No. H11-15798 discloses a technique for assigning control data to main storage and assigning a data element to extended storage if the size of the data element is equal to the access size of the extended storage. Assume that the size of data is equal to the access size of extended storage. In this case, even if the data is stored in the extended storage, the data to be accessed need not be locked at the time of writing and reading. The technique reduces the access time by storing the data in the extended storage. In other words, the technique of Japanese Patent Laid-Open No. H11-15798 implements a reduction in access time by controlling assignment of structure control data and structure data to be stored to main storage and extended storage according to the sizes of the main storage and extended storage.

However, neither of Japanese Patent Laid-Open No. 2003-337707 and Japanese Patent Laid-Open No. H11-15798 makes any reference to increasing the hit ratio at the time of access to cache memory by automatically converting access to a list of structures in a loop into access to an uninterrupted area by a compiler.

If an area is allocated for each structure (node) when assigning an area for a list vector in a program to be translated by a compiler, the areas for the structures may be separate in the memory space. Sequential access to the structures in a loop may cause degradation in performance such as a reduction in cache efficiency.

As a measure to prevent areas for structures from being separate, there can be considered a method of assigning structures to a static uninterrupted area instead of performing dynamic area assignment if the maximum of the size of an area is statistically determined (e.g., the size of an area pointed to by a structure pointer is fixed). However, if the size of an area to be used is unknown, it is impossible to assign structures to static uninterrupted area.

A case where the size of an area pointed to by a structure pointer is fixed refers to a case where an instruction is described in, e.g., the C language as follows:

p=(struct A*)malloc(sizeof(struct A)*10).

If an area for a list vector accessed by the program as shown in FIG. 13 is assigned to an uninterrupted area as shown in FIG. 14, the distance between a member (variable x in FIG. 14) of a given structure and a member of the same type of a structure which can be reached from the given structure through a next pointer “next” becomes constant.

This make it possible to prevent a cache miss in a list vector, for example, by an architecture which supports hardware prefetching by constant width access or software prefetching using assignment of the list vector as described above.

However, to implement this, a contrivance needs to be made such that areas for structures A are assigned to an uninterrupted area as shown in FIG. 14. The problem with allocation of an uninterrupted area is that the size of an area which will be ultimately needed is unknown when a request for allocation of an area for a structure A comes in. In this respect, a conventional compiler has not improved in optimization of list vector area assignment.

### SUMMARY OF THE INVENTION

In order to solve the above-described problem, the present invention has as its object to provide a compiling technique, which can generate an object program with good execution performance by assigning a list vector to an appropriate uninterrupted area at the time of execution of a program to be translated and reducing a cache miss.

In the present invention, upon detection of access to a list vector in a loop, an area allocation instruction to allocate an area and an area deallocation instruction (including a function or macroinstruction) are detected and converted into a unique new area allocation instruction and a unique new area deallocation instruction, respectively. The unique new area allocation instruction allocates a relatively large area on a first area allocation request and clips an area from the allocated area on a subsequent area allocation request. With this method, an interrupted area is automatically assigned to a list vector (a chain of structures), thereby implementing optimization by a compiler.

In other words, a compiling device detects a list vector to be sequentially accessed in a loop from a result of analyzing a source program to be translated and transcribes the area allocation instruction to allocate an area for a structure of the list vector into the new area allocation instruction. In the processing of the new area allocation instruction, a memory area of a size which is not less than an integral multiple of a size of an area for a structure is allocated, and an area is clipped from the memory area and assigned to a structure on a first call of the instruction. An area is clipped from the first allocated memory area and assigned to a structure on second and subsequent instructions.

The compiling device program also transcribes the area deallocation instruction corresponding to the area allocation instruction into the new area deallocation instruction. In the processing of the new area deallocation instruction, the whole of the memory area of the size, which is not less than the integral multiple of the size of an area for a structure, is deallocated when all areas in the memory area are deallocated.

According to the present invention, a compiling device transcribes an existing area allocation instruction and area deallocation instruction into the new area allocation instruction and new area deallocation instruction, respectively. Since areas for structures of a list vector used in a loop are assigned to an uninterrupted area, the number of occurrences of a cache miss decreases at the time of execution of the loop. Accordingly, the execution performance of a program containing a list vector is improved. Also, a page fault at the time of access to an area for a structure is reduced, and memory fragmentation is ameliorated. In particular, the present invention can improve the execution performance of an existing source program only by recompiling the source program without a program creator's transcription of the program.

### BRIEF DESCRIPTION OF THE DRAWINGS

FIG. 1 is a diagram for explaining the outline of the present invention;

FIG. 2 is a diagram showing an example of the configuration of a device which carries out the present invention;

FIG. 3 is a process flowchart of a list vector area optimization unit 72;

FIG. 4 is a diagram showing an example of a set of area managers when S areas are managed on a type-name by type-name basis;

FIG. 5 is a view showing specific examples of an area allocated by a function “listvec_malloc”;

FIG. 6 is a view showing specific examples of a type-specific area manager and an S area manager;

FIG. 7 is a process flowchart of a new area allocation instruction processing unit;

FIG. 8 is a process flowchart of a new area deallocation instruction processing unit;

FIG. 9 is a process flowchart of a new area allocation instruction processing unit prepared for each of types;

FIG. 10 is a process flowchart of a new area deallocation instruction processing unit prepared for each of types;

FIG. 11 is a diagram for explaining a list vector;

FIGS. 12 and 14 are a diagram showing an example of assignment of a list vector area to memory; and

FIG. 13 is a view showing an example of a program having a loop which accesses a list vector.

### DETAILED DESCRIPTION OF THE PREFERRED EMBODIMENTS

An embodiment in which the present invention is applied to a C language compiler will be explained below. The present invention can be applied not only to a C language compiler but also to a compiler for a computer language with which a list of structures can be described.

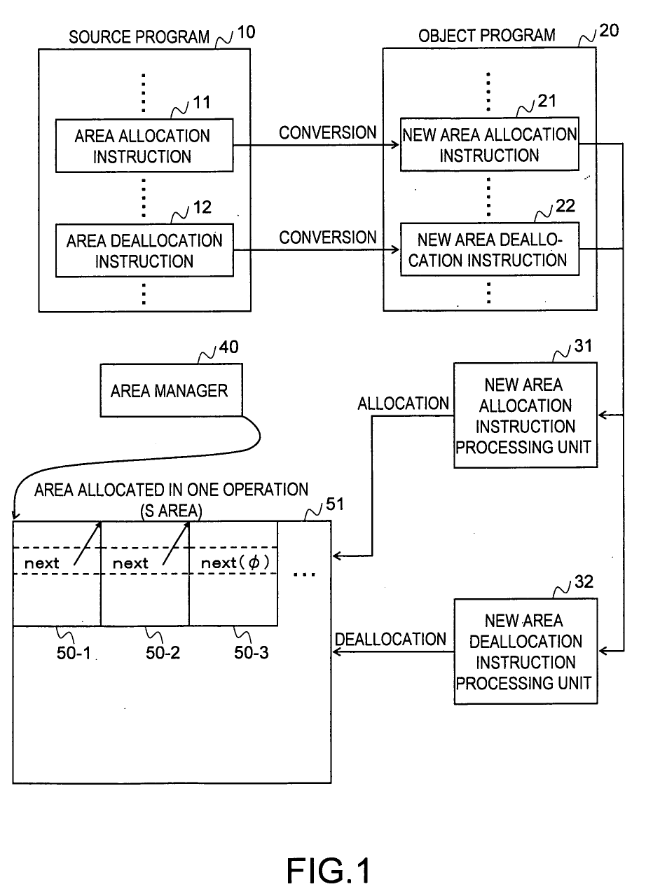

FIG. 1 is a diagram for explaining the outline of the present invention. In FIG. 1, reference numeral 10 denotes a source program described in the C language; and 20 denotes an object program as the result of translating the source program 10. In the source program 10, an area allocation instruction 11 is the function “malloc” for allocating a memory area in a C language program. An area deallocation instruction 12 is the function “free” for deallocating a memory area in a C language program. The object program 20 is a program composed of a sequence of machine instructions. However, instructions will be expressed in the same manner as a source program, for the sake of easy understanding of the following explanation.

The area allocation instruction 11 is targeted for processing in the present invention if it allocates an area for a structure of a list vector and particularly if the list vector is used in a loop of the program.

When a compiler detects a list vector used in a loop of the source program 10, it retrieves an occurrence of the area allocation instruction 11 which allocates an area for a structure of the list vector and replaces the occurrence with a new area allocation instruction 21. The compiler also retrieves an occurrence of the area deallocation instruction 12 which deallocates the area for the structure allocated by the occurrence of the area allocation instruction 11 and replaces the occurrence of the area deallocation instruction 12 with a new area deallocation instruction 22. The compiler outputs instruction codes of the instructions as the object program 20.

A linker processes the object program 20 to form an executable program. When the executable program is executed, a new area allocation instruction processing unit 31 is called by the new area allocation instruction 21.

For convenience of explanation, the executable program will also be referred to as the object program hereinafter.

Note that the new area allocation instruction processing unit 31 and a new area deallocation instruction processing unit 32 are programs prepared as a dynamic link library (DLL). These units may instead be prepared as a library to be statically linked in advance.

On a first call of the new area allocation instruction processing unit 31, the new area allocation instruction 21 allocates an area of memory of a size which is not less than n (n≧2) times that of an area for one structure as an area 51 allocated in one operation (to be also referred to as an S area hereinafter) and sets the area management information of the S area 51 in an area manager 40. The area manager 40 is a work area for storing the area management information of the S area 51. The new area allocation instruction 21 clips an area for a structure 50-1 requested by the object program 20 from the allocated S area 51 and returns the address of the clipped area as a return value to the issuer of the new area allocation instruction 21.

On a second call by the new area allocation instruction 21, the new area allocation instruction processing unit 31 clips an area for a next structure 50-2 from the already allocated S area 51 and returns the address of the clipped area as a return value to the issuer of the new area allocation instruction 21. The same applies to third and subsequent calls. With this series of operations, the structures 50-1, 50-2, 50-3, . . . are assigned to the uninterrupted area. Assume that the S area 51 is used up for assignment of areas for structures. On a call of the new area allocation instruction processing unit 31 after that, the process of further allocating another area of the memory as the next S area 51 and assigning an area for a new structure, which is the same processing as that on the first call, is performed again. Note that the status of use and the status of assignment for each of areas for structures in each S area 51 are held in the area manager 40.

When the new area deallocation instruction 22 is executed at the time of execution of the object program 20, the new area deallocation instruction processing unit 32 is called. The new area deallocation instruction processing unit 32 updates, on the basis of the address of an area for a structure for which a deallocation request is issued, the status of use of the area for the structure held in the area manager 40. For example, an area state flag indicating whether a structure is in use is prepared in advance as a status of use for each of structures. In response to a deallocation request, the area state flag of a corresponding structure is set to OFF. The new area deallocation instruction processing unit 32 deallocates each S area 51 and returns it to the system only after the area state flags of all the structures in the S area 51 are set to OFF.

The processing performed by the compiler to implement the processing shown in FIG. 1 will be explained in detail. In this embodiment, assignment of a list vector to be sequentially accessed in a loop to an uninterrupted area as shown in FIG. 14 is implemented by the process below. This prevents a cache miss on the fetch of an instruction in a loop, a page fault, and memory fragmentation and allows high-speed execution.

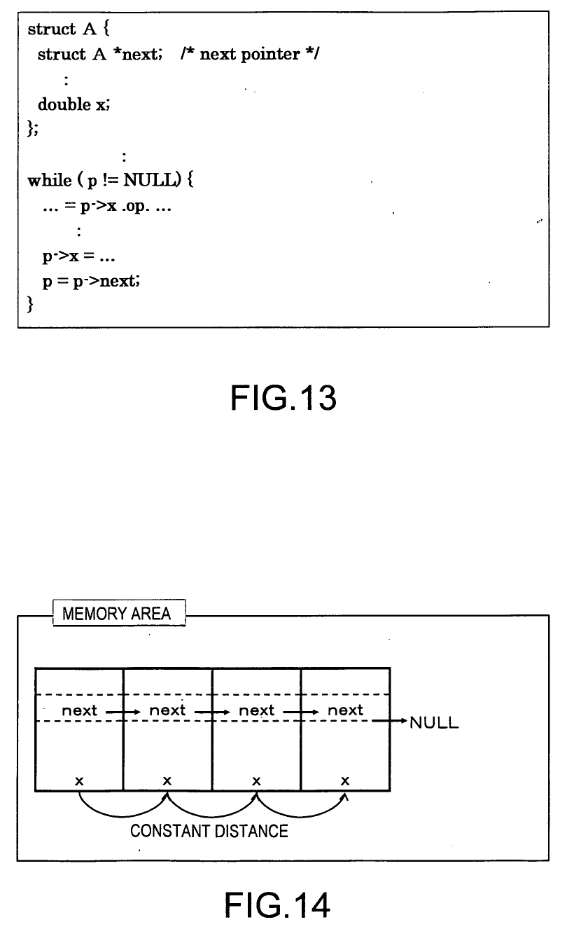

(1) A pointer for accessing a list is searched for with a focus on a loop and found. More specifically, a loop as shown in FIG. 13 which updates a structure pointer in a manner like “p=p→next” and determines whether to terminate using a condition like “p!=NULL” or “p==NULL” is detected.

(2) Instructions to allocate and deallocate an area for a structure pointed to by the pointer, i.e., the function “malloc” (area allocation instruction) and the function “free” (area deallocation instruction) are converted into a unique allocator function (new area allocation instruction) and a unique free function (new area deallocation instruction), respectively.

The unique allocator function allocates an area of a size which is not less than n (n≧2) times a required size on a first allocation request. Assume that the size of the area is S bytes. On subsequent allocation requests, the process of clipping an area of a necessary size from the first allocated area is performed. If the allocated area is used up, an area of a size of S bytes is allocated again. On subsequent allocation requests, an area is clipped from the new S area. In this manner, an uninterrupted area is assigned to a list vector.

In (1), whether the loop is repeated is entirely unclear except when the number of repetitions of the loop is statically known. Accordingly, the size of an uninterrupted area to be allocated for structures A is estimated using the three methods below, and an S area of an appropriate size is allocated.

[Method for Determining Size of S Area]

Method 1: The number of times a loop including a list vector is repeated is estimated using profile information (the size of an area used obtained as the result of trial execution), and the number of bytes required for an uninterrupted area to be allocated is determined. More specifically, the object program 20 is executed by way of experiment, and the execution history information is recorded as profile information. The size of an S area is determined on the basis of the number of repetitions of the loop at the time of execution and the like. For example, if the number of repetitions of a loop which accesses a structure of a size of 16 bytes is 100, the size of an S area is set to 16×100 bytes. Note that the size of an S area is set not to exceed that of cache memory.

Method 2: Designation of the number of bytes required for a list vector for which prevention of a cache miss is desired is left to a user. For example, a user inputs designation information requesting allocation of an area of a size of 400 bytes (4 bytes per structure×100) as a request for allocation of an area for structures A, as a parameter used at the time of translation such as a compile option.

Method 3: Under the assumption that a loop is repeated, the compiler appropriately determines the size of an S area on the basis of a preset value. For example, on the assumption that the loop is repeated N times (N is a preset value), an area of a size of (sizeof(A)*N) bytes is allocated as an S area.

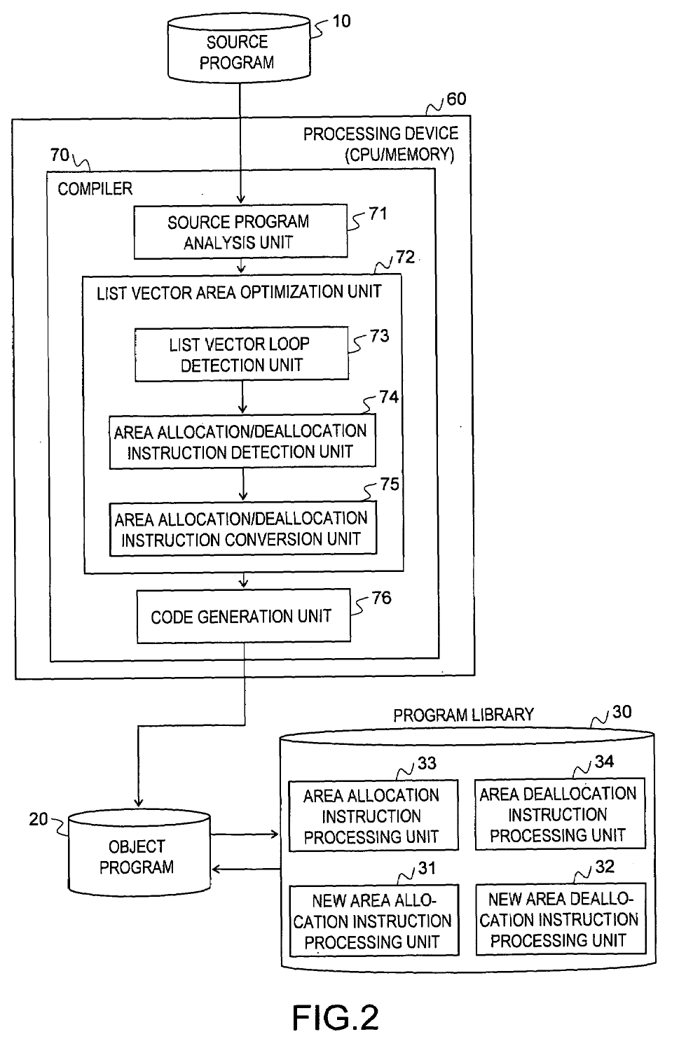

FIG. 2 is a diagram showing an example of the configuration of a device which carries out the present invention. In FIG. 2, reference numeral 10 denotes the source program 10 to be translated; 20 denotes the object program 20 as a translation result; and 30 denotes a program library 30 in which programs to be called by the object program 20 are stored. A program for an area allocation instruction processing unit 33 which handles the function “malloc” and a program for an area deallocation instruction processing unit 34 which handles the function “free” are stored in advance in the program library 30. Programs for the new area allocation instruction processing unit 31 and new area deallocation instruction processing unit 32, which handle functions for allocating and deallocating an uninterrupted area for a list vector, are also stored in the program library 30.

In this example, an explanation will be given using a function “listvec_malloc” as a function which calls the new area allocation instruction processing unit 31 and a function “listvec_free” as a function which calls the new area deallocation instruction processing unit 32.

A processing device 60 is a computer composed of a CPU, memory, and the like. A compiler 70 is a program which translates the source program 10 described in a high-level language into the object program 20 composed of a sequence of machine instructions. A source program analysis unit 71 receives the source program 10 to be translated and performs analysis processes such as syntactic analysis and semantic analysis. A list vector area optimization unit 72 includes a list vector loop detection unit 73, an area allocation/deallocation instruction detection unit 74, and an area allocation/deallocation instruction conversion unit 75. Note that the compiler 70 has various other optimization units. However, since portions unrelated to the present invention may be the same as those of a conventional technique, an explanation of the portions will be omitted. A code generation unit 76 performs register assignment for a sequence of instructions on the basis of a processing result from the list vector area optimization unit 72 and outputs a sequence of machine instructions as the object program 20.

The list vector loop detection unit 73 in the list vector area optimization unit 72 detects a loop such as a “for” statement or “while” statement including access to a list vector in the source program 10 and detects the type of the list vector detected in the loop. The area allocation/deallocation instruction detection unit 74 detects occurrences of the function “malloc” which allocates an area for the list vector detected by the list vector loop detection unit 73 and occurrences of the function “free” which deallocates the area. The area allocation/deallocation instruction conversion unit 75 converts each of the detected occurrences of the function “malloc” and each of those of the function “free” into the function “listvec_malloc” for calling the new area allocation instruction processing unit 31 and the function “listvec_free” for calling the new area deallocation instruction processing unit 32, respectively.

For this reason, at the time of execution of the object program 20, the new area allocation instruction processing unit 31 is called when allocating an area for a structure of a list vector used in a loop, and the new area deallocation instruction processing unit 32 is called when deallocating the area for the structure.

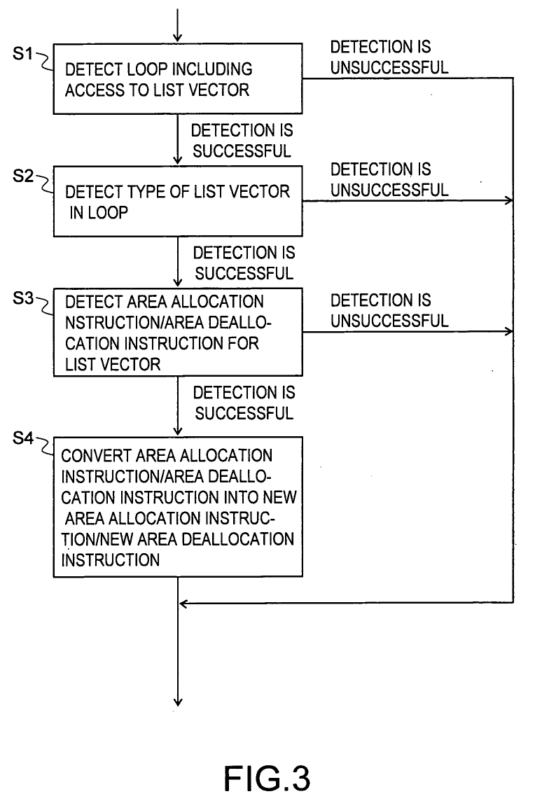

FIG. 3 is a process flowchart of the list vector area optimization unit 72. The list vector loop detection unit 73 executes steps S1 and S2, the area allocation/deallocation instruction detection unit 74 executes step S3, and the area allocation/deallocation instruction conversion unit 75 executes step S4.

In step S1, the list vector loop detection unit 73 first detects a loop including access to a list vector, i.e., a loop having an instruction to access structures of a list vector by tracing addresses pointed to by a pointer. If the list vector loop detection unit 73 has failed in detecting a loop, it does not perform list vector area assignment optimization.

If the list vector loop detection unit 73 has succeeded in detecting a loop including access to a list vector, it detects the type of the list vector pointed to by a pointer in step S2. If the list vector loop detection unit 73 has failed in detecting the type, it does not perform list vector area assignment optimization.

If the list vector loop detection unit 73 has succeeded in detecting the type, the area allocation/deallocation instruction detection unit 74 detects an occurrence of the function “malloc” which allocates an area for a structure and initializes the pointer and an occurrence of the function “free” which deallocates the area and deallocates the pointer in step S3. In step S4, the area allocation/deallocation instruction conversion unit 75 converts the detected occurrences of the function “malloc” and function “free” into the function “listvec_malloc” (new area allocation instruction) and the function “listvec_free” (new area deallocation instruction), respectively.

Note that of all occurrences of the function “malloc” which initialize a pointer, only ones which allocate an area for one structure are targeted for conversion into the function “listvec_malloc”. That is, occurrences of the functions “malloc” and “free” are targeted for conversion into the functions “listvec_malloc” and “listvec_free” only if they allocate an area by or deallocate an area allocated by “malloc” (“sizeof(structure type name)”).

The size of the S area 51 to be allocated by the function “listvec_malloc” is determined, e.g., in the following manner. Let MAX be the maximum of the size of an area required for a certain list vector, and S, the size of the S area 51 for sequential assignment to be allocated in one operation. The size S is represented by:

S=sizeof(A)*N (where N is an integer) [bytes]

The size S is selected such that the following expression holds:

(primary cache line size)*M≦S≦MIN

(MAXS, primary cache size)

(where M is an integer)

MIN(MAXS, primary cache size) returns the smaller of MAXS and primary cache size. If S is smaller than “(primary cache line size*M)”, the conversion is not performed.

If an occurrence of the function “malloc” detected in step S3 of FIG. 3 is converted into the function “listvec_malloc” in step S4, for example, the following statement:

p=(struct A*)malloc(sizeof(struct A));

is converted into:

p=(struct A*)listvec_malloc(sizeof(struct A), “struct A”);.

If the function “free” detected in step S3 is converted into the function “listvec_free”, for example, the following statement:

free(p);

is converted into:

listvec_free(p);.

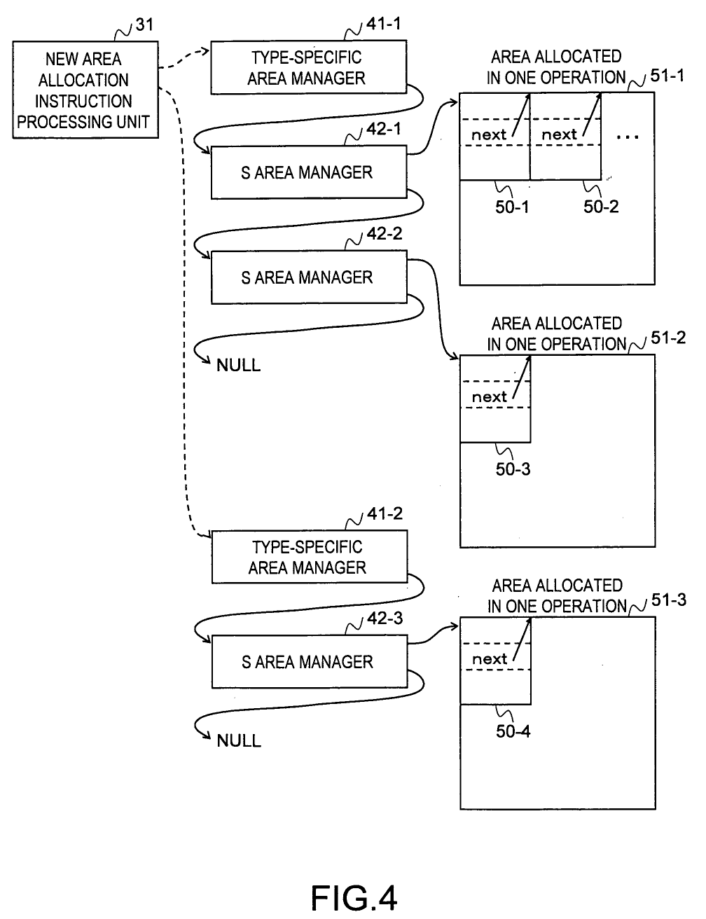

FIG. 4 shows an example of a set of area managers when S areas are managed on a type-name by type-name basis. The new area allocation instruction processing unit 31 called by the function “listvec_malloc” receives the type name of a list vector as an argument of the function and creates type-specific area managers 41-1, 41-2, . . . for respective type names. The type-specific area managers 41-1, . . . manage S area managers 42-1, . . . , respectively. The S area managers 42-1, . . . are created corresponding to areas 51-1, . . . allocated in one operation (S areas) each of which is an uninterrupted area. The S area managers 42-1, . . . are chained together on a type-by-type basis.

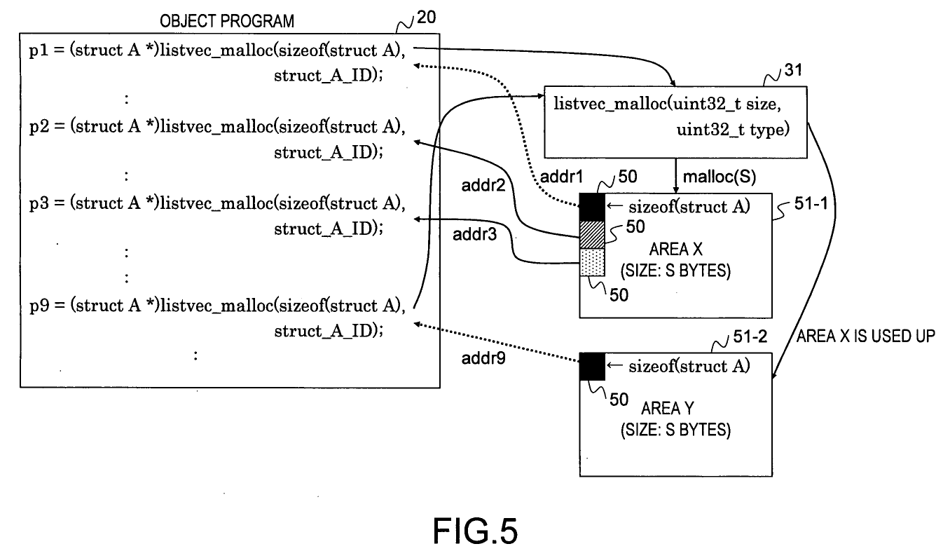

FIG. 5 shows specific examples of an area allocated by the function “listvec_malloc”. In the function “listvec_malloc”, the area size and type name of a structure A are passed to the new area allocation instruction processing unit 31 as arguments. At a first occurrence of the function “listvec_malloc”, the new area allocation instruction processing unit 31 allocates the S area 51-1 (area X) of S bytes, clips an area for one structure 50 from the top of the S area 51-1, and returns an address addr1 of the area as a return value. The address “addr1” is stored in a pointer “p1”. At a next occurrence of the function “listvec_malloc”, the new area allocation instruction processing unit 31 does not allocate a new S area. The new area allocation instruction processing unit 31 clips an area for the next structure 50 from the S area 51-1 as the already allocated area X and returns an “addr2” of the area as a return value. The address “addr2” is stored in a pointer “p2”.

If the area X is used up, and no more area for the structure 50 can be clipped from the S area 51-1 as the area X, the new area allocation instruction processing unit 31 allocates a new S area 51-2, clips an area for the structure 50 from the S area 51-2, and performs assignment. In the example of FIG. 5, at a ninth occurrence of the function “listvec_malloc”, the new area allocation instruction processing unit 31 allocates the new S area 51-2 and returns an “addr9” of an area for the structure 50 clipped from the S area 51-2 as a return value. The address “addr9” is stored in a pointer “p9”.

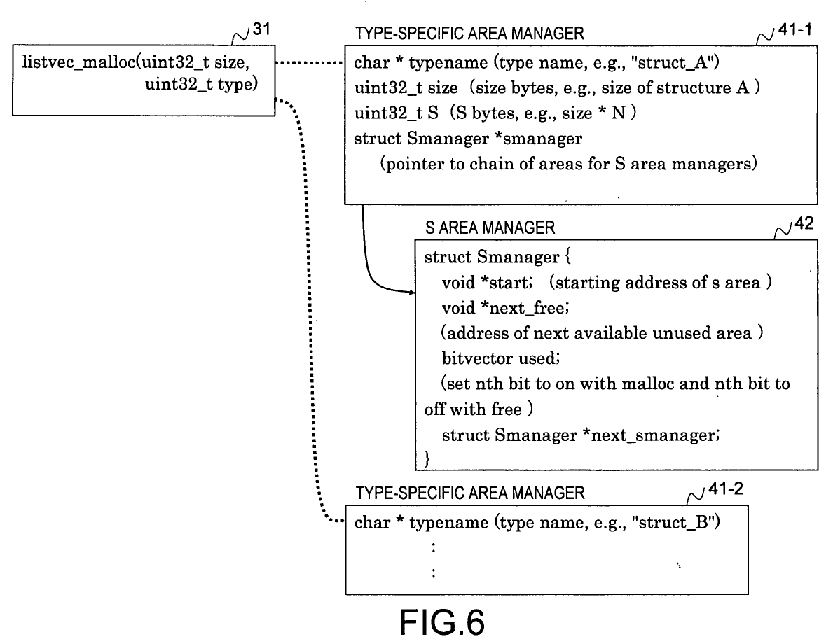

FIG. 6 shows specific examples of a type-specific area manager and an S area manager. The type-specific area managers 41-1, . . . each have type-specific information, i.e., pieces of information such as a type name (e.g., “struct_A”), the size of a structure (“size”), the size of an S area (“size*N”), and a pointer to a chain of areas for S area managers.

An S area manager 42 has pieces of information such as the starting address of an S area, the address of an unused area which can be assigned to a next structure in the S area, area state flags each indicating whether an area for a corresponding structure is in use, and a pointer to a next S area manager. The area state flags are expressed using a bit vector named “used”. If areas for N structures can be clipped from one S area, the bit vector is composed of N flags. The initial value of each flag is OFF (“0”). If an area which is the nth from the top is clipped and assigned as an area for a structure, an nth flag is changed to ON (“1”). If the nth area for the structure is deallocated by the function “listvec_free”, the nth one of the area state flags is reset to OFF (“0”).

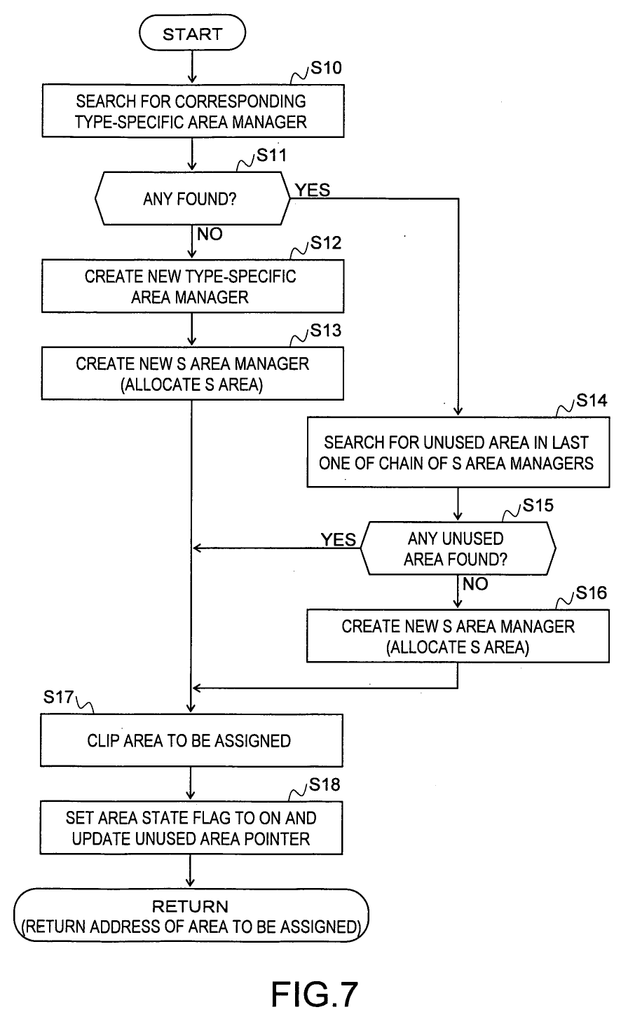

FIG. 7 is a process flowchart of the new area allocation instruction processing unit. The new area allocation instruction processing unit 31 is called by, e.g., an instruction description with arguments as follows:

void*listvec_malloc(unit32_t size, char*typename);.

First, in step S10, the new area allocation instruction processing unit 31 searches for a type-specific area manager whose area size is equal to “size” and whose type name coincides with “typename”. In step S11, the new area allocation instruction processing unit 31 determines whether a corresponding type-specific area manager is found. If a corresponding type-specific area manager is found, the flow advances to step S14. If no corresponding type-specific area manager is found, the flow advances to step S12.

In step S12, the new area allocation instruction processing unit 31 creates a new type-specific area manager (“tmanager”). A type-specific area manager is created, e.g., as follows:

type name=“struct A”;

size=the size of struct A (the number of bytes);

S=size*N;

smanager=creation of a new S area manager;

latest_Smanager=NULL; /* initialize a pointer to a last S area manager */.

As processing corresponding to the description “smanager=creation of a new S area manager;,” the new area allocation instruction processing unit 31 creates an S area manager (“smanager”) in step S13 as follows:

start=malloc(S); /* allocate an S area of a size of S bytes */

next_free=start; /* initialize an unused area pointer */

bitvector used; /* initialize area state flags */

next_smanager=NULL; /* initialize a pointer to a next one of a chain of S areas */

After that, the flow advances to step S17.

In steps S14 and S15, the new area allocation instruction processing unit 31 searches for an unused area (empty area) in an S area managed by a last one of a chain of S area managers and determines whether there is any unused area. In this example, the following processing is first performed:

latest_Smanager=tmanager→smanager;

It is then determined whether the following condition holds:

latest_Smanager→next_free>=latest_Smanager→start+S.

If there is any unused area, the flow advances to step S17. On the other hand, if there is no unused area left in the last S area, the flow advances to step S16.

In step S16, the new area allocation instruction processing unit 31 creates a new S area manager (“smanager”) as follows:

new_Smanager=creation of the new S area manager;

tmanager→smanager=new_Smanager;

new_Smanager→next_smanager=latest_Smanager;

latest_Smanager=new_Smanager;.

In “new_Smanager=creation of the new S area manager;” on the first line, the new area allocation instruction processing unit 31 performs the following processing in the same manner as in step S13:

start=malloc(S); /* allocate an S area of a size of S bytes */

next_free=start; /* initialize an unused area pointer */

bitvector used; /* initialize area state flags */

next_smanager=NULL; /* initialize a pointer to a next one of the chain of S areas */.

In steps S17 and S18, the new area allocation instruction processing unit 31 clips an area to be assigned to a structure from the S area, sets the area state flag for the area to ON, and updates an unused area pointer. The new area allocation instruction processing unit 31 returns the address of the area to be assigned clipped from the S area to the source of the request for area allocation (the issuer of a call to the function “listvec_malloc”), and the process ends. More specifically, the new area allocation instruction processing unit 31 performs the following processing:

n=get_nbit(latest_Smanager, latest_Smanager→next_free);

The S area manager pointed to by “latest_Smanager” manages N areas, and the function “get_nbit( )” is a function which returns where in the sequence of areas an area pointed to by “latest_Smanager→next_free” as the argument is located.

The setting of the corresponding area state flag is performed by the following function:

bitvector_on(latest_Smanager→used, n);

The function sets an nth area state flag to ON, and the set flag indicates that the nth area is in use.

The address of the area to be assigned is “latest_Smanager→next_free”. The new area allocation instruction processing unit 31 updates the unused area pointer as follows:

latest_Smanager→next_free+=size;

Return of the address of the area to be assigned is implemented by the following description:

return “the address of the area to be assigned”;.

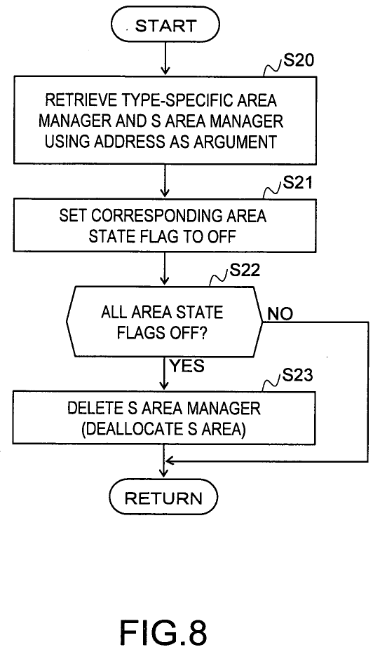

FIG. 8 is a process flowchart of the new area deallocation instruction processing unit. The new area deallocation instruction processing unit 32 is called by, e.g., an instruction description with an argument as follows:

void listvec_free(void*p);

### The new area deallocation instruction processing unit 32 is called by the function “listvec_free” when “size” bytes from an address “p” as the argument become unnecessary.

In step S20, the new area deallocation instruction processing unit 32 retrieves a type-specific area manager (tmanager) and S area manager (smanager) which manage the address “p” as the passed argument on the basis of the address “p” as the argument. In step S21, the new area deallocation instruction processing unit 32 sets, to OFF, an area state flag corresponding to the address “p” as the argument of a “bitvector used” managed by the retrieved S area manager. More specifically, the new area deallocation instruction processing unit 32 obtains the information that a flag for the address “p” is the nth from the top by:

n=get_nbit(smanager, p);

The new area deallocation instruction processing unit 32 sets the corresponding area state flag to OFF by:

bitvector_off(smanager→used, n);.

In step S22, the new area deallocation instruction processing unit 32 determines whether area state flags (“used”) of the S area manager are all set to OFF. If there is any flag set to ON, the process ends without deallocation. When all area state flags are set to OFF, the S area manager becomes unnecessary, and the flow advances to step S23. In step S23, the new area deallocation instruction processing unit 32 deallocates an area managed by the S area manager and excludes the S area manager from the control of the type-specific area manager. More specifically, the new area deallocation instruction processing unit 32 deallocates the S area by the function “free” (area deallocation instruction) as follows:

free(smanager→start);

### The new area deallocation instruction processing unit 32 excludes “smanager” from a list of S area managers under the control of the type-specific area manager.

With this series of operations, it is possible to assign an uninterrupted area of a size (S bytes) which is relatively large, if not as large as a list vector formed of structures A, to the list vector.

An example in which the type name of a list vector is used both as an argument of the function “listvec_malloc” and that of the function “listvec_free”, and the new area allocation instruction processing unit 31 and new area deallocation instruction processing unit 32 each manage an S area on a type-by-type basis has been explained above.

The present invention, however, is not limited to an implementation example in which type-specific area managers are provided to manage S areas on a type-by-type basis. There is also available an implementation example in which the new area allocation instruction processing unit 31 and new area deallocation instruction processing unit 32 are prepared in advance for each of types. That is, an implementation example in which a combination of the functions “listvec_malloc” and “listvec_free” is separately prepared for each of types of structures can produce the same effect as the above-described example.

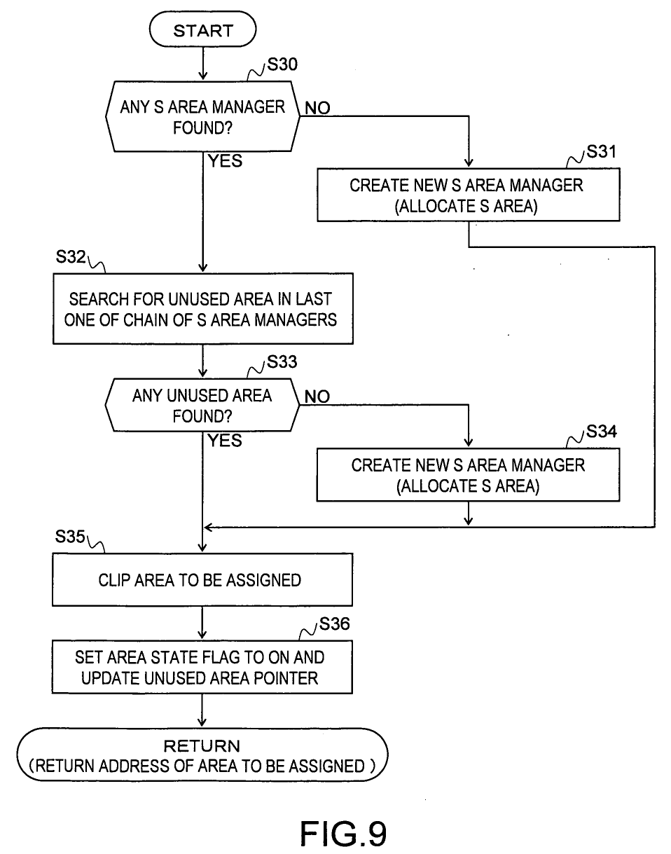

FIG. 9 is a process flowchart of the new area allocation instruction processing unit prepared for each of types. The new area allocation instruction processing unit 31 for a structure A is called by, e.g., an instruction description with an argument as follows:

void*listvec_malloc_forA(unit32_t size);

The new area allocation instruction processing unit 31 for each type may be deemed to have only the S area manager 42 in FIG. 6.

First, in step S30, the new area allocation instruction processing unit 31 determines whether there is any S area manager for a structure A, on the basis of whether the following condition is true:

latest_Smanager==NULL?

### If there is any S area manager, the flow advances to step S32. If there is no S area manager, i.e., if “latest_Smanager==NULL”, the flow advances to step S31.

In step S31, the new area allocation instruction processing unit 31 creates a new S area manager.

latest_Smanager=creation of a new S area manager;

In “creation of a new S area manager;,” the new area allocation instruction processing unit 31 performs the following processing:

start=malloc(S); /* allocate an S area of a size of S bytes */

next_free=start; /* initialize an unused area pointer */

bitvector used; /* initialize area state flags */

next_smanager=NULL; /* initialize a pointer to a next one of a chain of S areas */

### After that, the flow advances to step S35.

In steps S32 and S33, the new area allocation instruction processing unit 31 searches for an unused area (empty area) in an S area managed by a last one of a chain of S area managers and determines whether there is any unused area. In this example, it is determined whether the following condition holds:

latest_Smanager→next_free>=latest_Smanager→start+S;

If there is any unused area, the flow advances to step S35. On the other hand, if there is no unused area left in the last S area, the flow advances to step S34.

In step S34, the new area allocation instruction processing unit 31 creates a new S area manager (smanager) as follows:

new_Smanager=creation of the new S area manager;

new_Smanager→next_smanager=latest_Smanager;

latest_Smanager=new_Smanager;

In “new_Smanager=creation of the new S area manager;” on the first line, the new area allocation instruction processing unit 31 performs the following processing in the same manner as in step S31:

start=malloc(S); /* allocate an S area of a size of S bytes */

next_free=start; /* initialize an unused area pointer */

bitvector used; /*initialize area state flags */

next_smanager=NULL; /* initialize a pointer to a next one of the chain of S areas */.

In steps S35 and S36, the new area allocation instruction processing unit 31 clips an area to be assigned to a structure from the S area, sets the area state flag for the area to ON, and updates an unused area pointer. The new area allocation instruction processing unit 31 returns the address of the area to be assigned clipped from the S area to the source of the request for area allocation (the issuer of a call to the function), and the process ends. More specifically, the new area allocation instruction processing unit 31 performs the following processing:

n=get_nbit(latest_Smanager, latest_Smanager→next_free);

The S area manager pointed to by “latest_Smanager” manages N areas, and the function “get_nbit( )” is a function which returns where in the sequence of areas an area pointed to by “latest_Smanager→next_free” as the argument is located.

The setting of the corresponding area state flag is performed by the following function:

bitvector_on(latest_Smanager→used, n);

The function sets an nth area state flag to ON, and the set flag indicates that the nth area is in use.

The address of the area to be assigned is “latest_Smanager→next_free”. The new area allocation instruction processing unit 31 updates the unused area pointer as follows:

latest_Smanager→next_free+=size;

Return of the address of the area to be assigned is implemented by the following description:

return “the address of the area to be assigned”;.

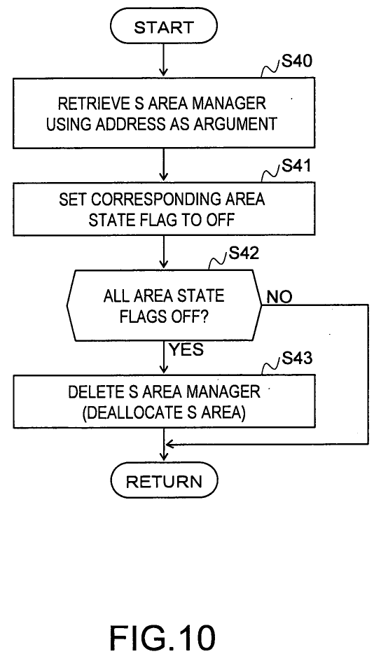

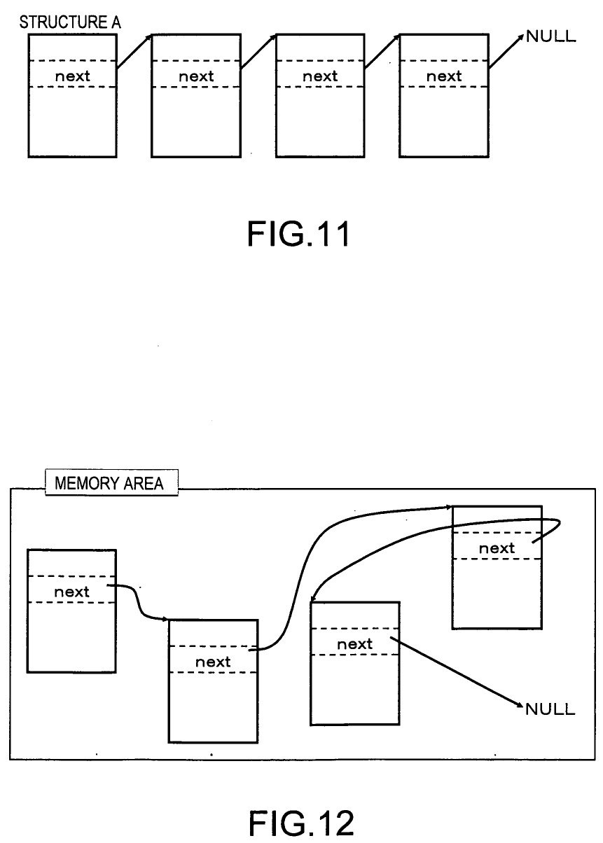

FIG. 10 is a process flowchart of the new area deallocation instruction processing unit prepared for each of types. The new area deallocation instruction processing unit 32 for each type is called by, e.g., an instruction description with an argument as follows:

void listvec_free_forA(void*p);

### The new area deallocation instruction processing unit 32 is called when “size” bytes from an address p as the argument become unnecessary.

In step S40, the new area deallocation instruction processing unit 32 retrieves an S area manager (smanager) which manages the address “p” passed as the argument from a chain of S area managers starting from an address pointed to by “latest_Smanager”. In step S41, the new area deallocation instruction processing unit 32 sets, to OFF, an area state flag corresponding to the address “p” as the argument of a “bitvector used” managed by the retrieved S area manager. More specifically, the new area deallocation instruction processing unit 32 obtains the information that a flag for the address “p” is the nth from the top by:

n=get_nbit(smanager, p);

The new area deallocation instruction processing unit 32 sets the corresponding area state flag to OFF by:

bitvector_off(smanager→used, n);.

In step S42, the new area deallocation instruction processing unit 32 determines whether area state flags (“used”) of the S area manager are all set to OFF. If there is any flag set to ON, the process ends without deallocation. When all area state flags are set to OFF, the S area manager becomes unnecessary, and the flow advances to step S43. In step S43, the new area deallocation instruction processing unit 32 deallocates an area managed by the S area manager and excludes the S area manager from the chain under the control. More specifically, the new area deallocation instruction processing unit 32 deallocates the S area by the function free (area deallocation instruction) as follows:

free(smanager→start);

The new area deallocation instruction processing unit 32 excludes “smanager” from the list of S area managers. If “latest_Smanager” is equal to “smanager”, “smanager→next smanager” is substituted for “latest_Smanager”.

The above-explained processing performed by the compiler 70, new area allocation instruction processing unit 31, and new area deallocation instruction processing unit 32 can be implemented by a combination of a computer and a software program. The program may be provided in the form of a computer-readable recording medium having the program recorded thereon or may be provided over a network.

What is claimed is:

1. A compiling device which receives a source program and translates the source program into an object program, comprising:
a list vector loop detection unit for detecting a loop including access to a list vector composed of a chain of structures on the basis of a result of analyzing the source program;
an area allocation/deallocation instruction detection unit for detecting an instruction to allocate, from memory, an area for a structure in the list vector to be accessed in the detected loop and an instruction to deallocate an area for a structure;
an area allocation/deallocation instruction conversion unit for transcribing the detected instruction to allocate an area for a structure into a new area allocation instruction to call a new area allocation instruction processing unit which allocates an uninterrupted area of a size which is not less than n (n≧2) times a size of the area for the structure, clips an area from the uninterrupted area, and assigns the area to the structure on a first call and clips an area from the allocated uninterrupted area and assigns the area to the structure on second and subsequent calls and transcribing the detected instruction to deallocate an area for a structure into a new area deallocation instruction to call a new area deallocation instruction processing unit which manages a status of use for each of areas for structures in the uninterrupted area and deallocates the uninterrupted area when all of the areas for the structures enter an unused state; and
a code generation unit for generating a code including an instruction converted by the area allocation/deallocation instruction conversion means and outputting the code as the object program.

2. The compiling device according to claim 1, wherein
a value of n, which defines the size of the uninterrupted area allocated by the new area allocation instruction processing unit, is determined on the basis of profile information which is obtained at the time of trial execution of the object program and in which the number of times the loop is executed is recorded.

3. The compiling device according to claim 1, wherein
a value of n, which defines the size of the uninterrupted area allocated by the new area allocation instruction processing unit, is one of a value determined by compile option information and a value designated as a parameter used at the time of execution of the object program.

4. The compiling device according to claim 1, wherein
a value of n, which defines the size of the uninterrupted area allocated by the new area allocation instruction processing unit, is predetermined as a set value for a compiler.

5. The compiling device according to claim 1, wherein
the size of the uninterrupted area allocated by the new area allocation instruction processing unit is smaller than a size of cache memory of a computer on which the object program is running and larger than a line size of the cache memory.

6. A list vector area assignment optimization method executed by a computer equipped with a compiler program which receives a source program and translates the source program into an object program, comprising:
a list vector loop detection step of detecting a loop including access to a list vector composed of a chain of structures on the basis of a result of analyzing the source program;
an area allocation/deallocation instruction detection step of detecting an instruction to allocate, from memory, an area for a structure in the list vector to be accessed in the detected loop and an instruction to deallocate an area for a structure;
an area allocation/deallocation instruction conversion step of transcribing the detected instruction to allocate an area for a structure into a new area allocation instruction to call a new area allocation instruction processing unit which allocates an uninterrupted area of a size which is not less than n (n≧2) times a size of the area for the structure, clips an area from the uninterrupted area, and assigns the area to the structure on a first call and clips an area from the allocated uninterrupted area and assigns the area to the structure on second and subsequent calls and transcribing the detected instruction to deallocate an area for a structure into a new area deallocation instruction to call a new area deallocation instruction processing unit which manages a status of use for each of areas for structures in the uninterrupted area and deallocates the uninterrupted area when all of the areas for the structures enter an unused state; and
a code generation step of generating a code including an instruction converted in the area allocation/deallocation instruction conversion step and outputting the code as the object program.

7. The list vector area assignment optimization method according to claim 6, wherein
a value of n, which defines the size of the uninterrupted area allocated by the new area allocation instruction processing unit, is determined on the basis of profile information which is obtained at the time of trial execution of the object program and in which the number of times the loop is executed is recorded.

8. The list vector area assignment optimization method according to claim 6, wherein
a value of n, which defines the size of the uninterrupted area allocated by the new area allocation instruction processing unit, is one of a value determined by compile option information and a value designated as a parameter used at the time of execution of the object program.

9. The list vector area assignment optimization method according to claim 6, wherein
a value of n, which defines the size of the uninterrupted area allocated by the new area allocation instruction processing unit, is predetermined as a set value for a compiler.

10. The list vector area assignment optimization method according to claim 6, wherein
the size of the uninterrupted area allocated by the new area allocation instruction processing unit is smaller than a size of cache memory of a computer on which the object program is running and larger than a line size of the cache memory.

11. A computer-readable recording medium having thereon a compiler program which receives a source program and translates the source program into an object program, the compiler program being for causing a computer to function as:
detecting a loop including access to a list vector composed of a chain of structures on the basis of a result of analyzing the source program;
detecting an instruction to allocate, from memory, an area for a structure in the list vector to be accessed in the detected loop and an instruction to deallocate an area for a structure;
transcribing the detected instruction to allocate an area for a structure into a new area allocation instruction to call a new area allocation instruction processing unit which allocates an uninterrupted area of a size which is not less than n (n≧2) times a size of the area for the structure, clips an area from the uninterrupted area, and assigns the area to the structure on a first call and clips an area from the allocated uninterrupted area and assigns the area to the structure on second and subsequent calls and transcribing the detected instruction to deallocate an area for a structure into a new area deallocation instruction to call a new area deallocation instruction processing unit which manages a status of use for each of areas of structures in the uninterrupted area and deallocates the uninterrupted area when all of the areas for the structures enter an unused state; and
generating a code including an instruction converted by the area allocation/deallocation instruction conversion means and outputting the code as the object program.

12. The computer-readable recording medium according to claim 11, wherein
a value of n, which defines the size of the uninterrupted area allocated by the new area allocation instruction processing unit, is determined on the basis of profile information which is obtained at the time of trial execution of the object program and in which the number of times the loop is executed is recorded.

13. The computer-readable recording medium according to claim 11, wherein
a value of n, which defines the size of the uninterrupted area allocated by the new area allocation instruction processing unit, is one of a value determined by compile option information and a value designated as a parameter used at the time of execution of the object program.

14. The computer-readable recording medium according to claim 11, wherein
a value of n, which defines the size of the uninterrupted area allocated by the new area allocation instruction processing unit, is predetermined as a set value for a compiler.

15. The computer-readable recording medium according to claim 11, wherein
the size of the uninterrupted area allocated by the new area allocation instruction processing unit is smaller than a size of cache memory of a computer on which the object program is running and larger than a line size of the cache memory.
